(19) United States
(12) Patent Application Publication
(10) Pub. No.: US 2024/0346679 A1
(43) Pub. Date: Oct. 17, 2024

(54) Color-Based Object Detection and Location System

(71) Applicant: Jacob Gilshteyn, Santa Monica, CA (US)

(72) Inventor: Jacob Gilshteyn, Santa Monica, CA (US)

(21) Appl. No.: 18/239,922

(22) Filed: Aug. 30, 2023

Related U.S. Application Data
(60) Provisional application No. 63/459,702, filed on Apr. 17, 2023.

(51) Int. Cl. G06T 7/70; G06T 5/40; G06T 7/90; G06V 10/56

(52) U.S. Cl. CPC G06T 7/70; G06T 5/40; G06T 7/90; G06V 10/56; G06T 2207/10024; G06V 2201/07

(57) ABSTRACT

The invention pertains to a system for the detection and location of objects based on unique color wavelengths. A user captures an image of a target object, either selecting a color shade directly or defining a color range from the object, which is subsequently stored in the device's memory. In real-time object tracking mode, the system analyzes the live feed from a camera sensor, dynamically adjusting for varying lighting conditions and filtering visuals based on the pre-selected color or range. When a match is detected, feedback mechanisms, both visual and auditory, alert the user. This innovation offers utility in everyday scenarios for locating misplaced items, as well as professional applications where specific color detection is paramount. The system's adaptability to changing environments and its precision in color recognition position it as a unique solution in the realm of object detection.

### CROSS REFERENCE TO RELATED APPLICATIONS

This patent application claims the benefit of U.S. provisional Application No. 63/459,702 filed Apr. 17, 2023.

### FIELD OF INVENTION

The present invention relates generally to object detection and tracking systems. More specifically, it concerns a system and method for identifying and locating objects based on their unique color or color range using a camera or sensor-enabled device.

### BACKGROUND

The rapid advancement of technology and the increasing array of personal items in the modern era have intensified the challenge of misplacing or losing possessions. Traditional methods employed to address this problem, such as manual searching or devices emitting audio signals to aid location, are often fraught with limitations. While barcode and QR code scanning systems have been implemented to aid in the identification of items, these methods hinge upon the object having a pre-attached code and demand a direct line of sight for successful detection. Image recognition systems, aiming to match an entire object's appearance to a saved image, grapple with inaccuracies due to shifting perspectives, fluctuating lighting conditions, and potential obstructions.

Moreover, some solutions resort to technologies like GPS or Bluetooth for object tracking. While effective in broader geolocation contexts, they falter when it comes to pinpointing an item's precise location within confined spaces. These solutions further compound their limitations by necessitating the object to be fitted with a GPS or Bluetooth tag beforehand, rendering them ineffective for spontaneous tracking of any unscheduled item.

A glaring yet largely overlooked aspect in the realm of object detection is color—a fundamental attribute of most items. Prior systems that have dabbled in color-based detection have been stymied by an over-reliance on precise color matches. This hyper-specific approach proves to be a handicap in real-world scenarios where ambient lighting and shadows can dramatically alter an object's perceived hue. Additionally, many existing color-detection platforms show a marked inability to discern a spectrum or gradation of colors, stifling their adaptability. Coupled with often clunky user interfaces that impede effortless selection or modification of target colors, the inefficiencies of these systems become all the more pronounced.

The limitations inherent to these conventional methods underscore the pressing need for a more intuitive, versatile, and robust system for object identification and location. The impetus behind the present invention springs from acknowledging these technological voids and understanding the unparalleled value a sophisticated color-based object detection apparatus can bring to both everyday life and specialized professional scenarios.

It is within this context that the present invention is provided.

### SUMMARY

The present invention offers a groundbreaking system and method for identifying and locating objects based on their unique color or color range utilizing a camera or sensor-enabled device. Through leveraging the intrinsic color properties of objects, this innovation provides a reliable and efficient means of object detection, overcoming the limitations of traditional methods such as barcode scanning, image recognition, or GPS-based systems.

In some embodiments, the invention incorporates an advanced image processing algorithm. This algorithm ensures that upon capturing an image, normalization takes place to account for diverse lighting conditions, making certain that the selected color mirrors the real-world object as closely as possible. This specific feature ensures consistent and accurate color matching irrespective of the ambient light conditions, rendering the system reliable in a wide array of environments.

In some embodiments, the software of the invention allows for the selection of a ‘color range’ or ‘color tolerance’ instead of relying solely on an exact color match. This dynamic approach offers flexibility in real-world scenarios where lighting, reflections, or other environmental factors might cause slight deviations in the perceived color of an object. Such an approach facilitates a broader, more inclusive search parameter, boosting the likelihood of successfully locating the target object.

In another embodiment, the system employs a histogram analysis, which provides a graphical representation of the distribution of tones of colors in the captured image. This allows the software to discern even subtle color shades within a defined tolerance range, particularly vital when the object encompasses multiple shades of the same color.

In some embodiments, a real-time tracking algorithm continuously processes the live feed from the camera, dynamically adjusting the color range based on the ongoing feedback. This real-time adaptation capability ensures that the software remains receptive to changing conditions, such as transitioning from a sunlit environment to a shaded one.

In other embodiments, the system proffers a multi-modal feedback mechanism. Once the camera identifies an object matching the specified color range, it can isolate and visually highlight it. Additionally, the system can generate auditory alerts or vibratory feedback, ensuring that the user's attention is captured even if they are not actively observing the screen. This multi-pronged feedback enhances user experience and efficiency in object location.

Lastly, in certain embodiments, the invention's user interface is devised to be intuitive, allowing users to effortlessly select target colors, adjust tolerance levels, or choose from a color palette. The system's provision for both manual color specification and automated selection using saved images adds another layer of versatility, catering to both planned object tracking and spontaneous searches.

In essence, this invention amalgamates advanced image processing techniques with user-centered design, culminating in a comprehensive, reliable, and user-friendly object detection system based on color properties. Its multifaceted approach bridges the technological gaps seen in prior methods and promises unparalleled efficacy in both everyday and specialized applications.

### BRIEF DESCRIPTION OF THE DRAWINGS

Various embodiments of the invention are disclosed in the following detailed description and accompanying drawings.

FIG. 1 provides a block diagram illustrating the primary hardware components of the system, including a camera-enabled device with its processor, memory, and camera/sensor connections.

FIG. 2 showcases a flowchart diagram detailing the sequence of user interactions with the system, from initiating an image capture to receiving feedback upon object detection.

FIG. 3 offers a visual representation of the system's camera interface during the processes of color selection and real-time object identification, delineating both the user's color selection phase and the subsequent feedback mechanism upon object location.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terminology used herein is for the purpose of describing particular embodiments only and is not intended to be limiting.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DETAILED DESCRIPTION OF DRAWINGS

The present disclosure pertains to a system and method for identifying and locating objects grounded primarily on their distinct color properties. At the heart of the invention is a combination of a camera or a sensor-enabled device and a sophisticated image processing algorithm designed to discern objects within captured images based on a user-defined color or a range of colors.

The invention couples the camera or sensor-enabled device with a processor. This processor, working in tandem with a memory unit, stores and executes an image processing algorithm. The function of the algorithm spans from the normalization of captured images to accounting for diverse lighting conditions, thus ensuring that the identified color is an accurate representation of the real-world object. This bolsters the system's capability to reliably and accurately match the colors, irrespective of external environmental conditions.

Further, a salient aspect of the invention is its provision for a flexible approach in color identification. By allowing users not just to select an exact color shade but also a broader color range or tolerance, the system effectively navigates real-world scenarios. This accounts for external factors like lighting or reflections that might slightly modify the perceived color of an object. The utility of a color range means the system can cast a broader net, enhancing the probability of zeroing in on the target object.

Through the user interface, users can select target colors, tweak tolerance levels, or even choose colors from a predefined color palette. The blend of manual color specification tools and automated selection utilities rooted in saved images infuses the invention with a high degree of adaptability.

Embedded within the system is also a real-time tracking module that digests the live feed from the camera. By dynamically adjusting the color range based on real-time feedback, this feature ensures the system remains receptive and agile to evolving conditions.

Supplementing these technical aspects are feedback mechanisms, designed to offer users a comprehensive sensory experience. Once an object aligning with the specified color properties is detected, the system can employ an array of feedback modalities—be it visual highlights, auditory alerts, or vibratory signals.

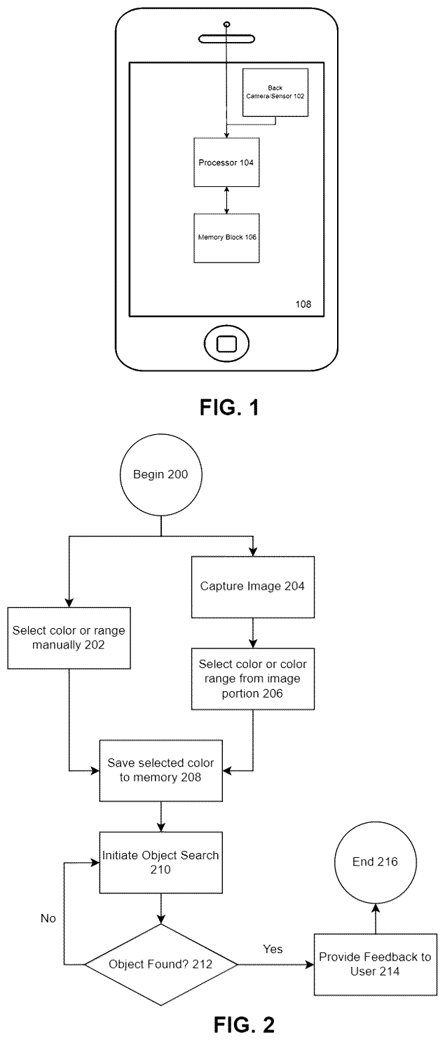

Referring to FIG. 1, an exemplary system overview diagram presents the integral components and flow of the System for Locating Objects Based on Color Recognition. The diagram depicts the structural organization and interconnections that make the invention functional, efficient, and user-friendly.

The central component in FIG. 1 is a smartphone or camera-enabled device 100. Represented as a standard rectangular shape, the device 100 is not limited to any particular model or brand but rather serves as a generic representation of any camera-equipped apparatus suitable for the invention's application. Equipped with a lens, the device 100 incorporates a back camera or sensor 102 as well as a front camera/sensor 103, responsible for capturing images or video of the real world.

Internal to the device 100, a processor 104 is shown. The processor 104 receives the data streams from the camera or sensors 102, 103 which are images or videos captured by the user.

Adjacent to the processor 104, the memory block 106 is depicted. The memory 106 serves a dual purpose: it stores the image processing algorithm that normalizes captured images to account for varying lighting conditions and stores the extracted color or color range data from user-captured images. This data storage is crucial for the system's ability to later identify and locate objects based on their distinct color properties.

On the visible face of the device 100, a user interface display 108 is illustrated. This interface 108 is where users interact with the system, enabling functionalities such as capturing reference images to determine and store an object's color, selecting specific sections of an object for color extraction, or manually choosing colors from a built-in palette. Indicators on the display 108 can highlight detected objects matching stored or selected color shades, utilizing techniques such as selective filtering, darkening, or highlight mechanisms.

Arrows within the device 100 demonstrate the interaction and flow between these components. Specifically, an arrow from the camera/sensor blocks 102, 103 to the processor 104 indicates the transfer of captured images. Additionally, a two-way arrow between the processor 104 and the memory block 106 signifies the storage of data after processing and the processor referencing stored color data in the memory, including the image processing algorithm's access and extracted color data.

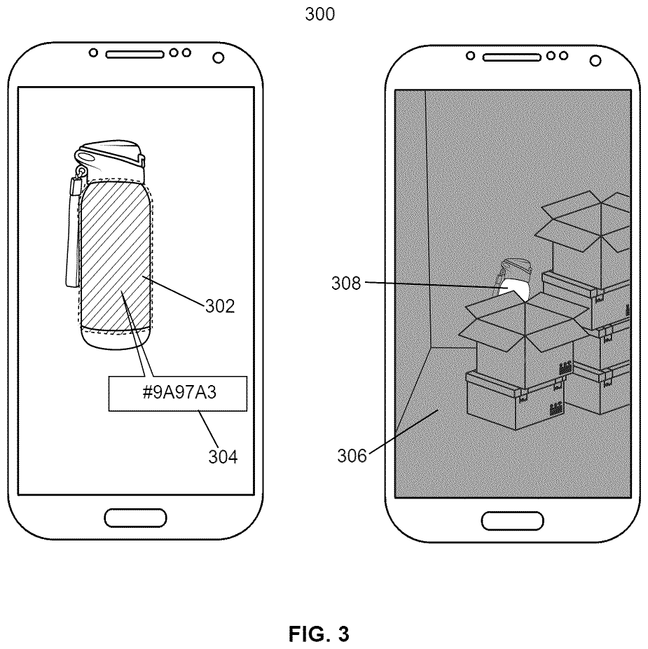

Referring to FIG. 2, a flowchart shows the sequence of user interactions when utilizing the System for Locating Objects Based on Color Recognition. The flowchart showcases the user-centric procedures and decisions involved, offering clarity on how the system streamlines object identification based on color.

The user's journey commences at the starting circle 200, aptly labeled “Begin.” It serves as the initiation point for the user's interaction with the device 100, as introduced in FIG. 1.

A user has two different routes to initiate the object detection process form here. They may simply “Select a color or range 202” that they wish to search for via the user interface, such as form a color palette or color wheel.

Alternatively, users may perform an “Capture Image 204” operation. Here, the user employs the camera or sensor 102 of the device 100 to acquire an image of the desired object, such as the earlier mentioned water bottle. Upon capturing the image, the flow progresses to the next rectangular block 206, labeled “Select Color or Color Range.” At this juncture, the user, through the user interface display 108, can designate specific regions of the captured object or manually choose colors from an integrated palette, accommodating both precise color extractions and broader color range selections, optimizing the chances of successful object detection later on.

Emerging from the color selection phase, whichever route they took for selecting a color, an arrow guides users to the subsequent action: “Save Selected Color to Memory,” depicted by rectangle 208. This step ensures the extracted color data, whether it's an exact shade or a range, is stored within the device's memory 106 for future retrieval and comparison.

Another arrow stems from the color-saving process, leading users to a new rectangle 210 labeled “Initiate Object Search.” At this stage, the system's real-time tracking algorithm becomes active, continually analyzing the live feed from the camera or sensor 102 to identify and highlight objects that match the saved or selected color data.

Following the object search, users encounter a critical decision-making point in their journey, represented by the diamond 212, titled “Object Found?” This diamond 212 poses a binary outcome-either ‘Yes’ or ‘No.’ If the system identifies an object within the camera's frame that matches the saved or selected color or color range, the ‘Yes’ branch activates. An arrow from this branch leads to a rectangle 214, labeled “Provide Feedback to User.” Feedback, which can be visual, auditory, or vibratory, as previously discussed, alerts the user about the detected object. Post feedback, the flow culminates at an ending circle 216, labeled “End,” marking the successful completion of the object location process.

However, if the system doesn't immediately identify a matching object, the ‘No’ branch from the decision diamond 212 becomes operational. It loops back, via an arrow, to the “Initiate Object Search” rectangle 210, indicating the system's persistence in continuously scanning the environment until a match is found or the user decides to halt the search.

Turning to FIG. 3, a visual portrayal of the device's camera interface is shown both during the act of color selection and at the moment an object of interest, based on color recognition, is detected.

The left half of FIG. 3 presents a simulated camera screen view 300, which shows an image that has been captured of an object with a specific segment highlighted—for our purposes, a water bottle. This highlighted section 302 captures the user's color selection phase. Adjacently, a color code 304 (in this instance, “#9A97A3”) is showcased, signifying the precise shade chosen by the user from the object. This color code representation provides an instant visual reference for the user, and facilitates accurate object detection in subsequent stages.

Contrasting with the left, the right portion of FIG. 3 shows an image of a camera feed of a room populated with objects, but with a portion of the object from the previously stored image visible and having been found to match the stored color, showcasing the system's ability to apply real-time color filtering and object identification.

The object has been detected by the system despite being at an angle and partially obscured by other objects, and is highlighted by a white filter 308, with the rest of room view 306 predominantly rendered in darkened grayscale. This selective desaturation draws attention to those objects whose color matches the earlier user-selected shade. In the context of our illustration, all entities aligning with the color code “#9A97A3”, or perhaps within a certain range of said shade, adjusted and normalized for lighting conditions, remain in their natural hue, standing out against the monochromatic darkened backdrop. This visual technique illuminates the system's capability of zoning in on the pertinent objects, filtering out unnecessary visual noise, and elevating the prominence of the target objects.

Other visual cues not shown might include an object adorned with a flashing border or accompanied by a directive arrow. These features, beyond just denoting the object's presence, embody the system's feedback mechanisms. They signify the moment of successful object detection, ensuring the user's attention is promptly and unmistakably drawn to the located item. The implementation of such overt indicators reiterates the system's commitment to ensuring a seamless and efficient user experience during the object location process.

### Network Components

Although oft described with specific reference to smartphones, the operations described herein can be carried out by any suitable type of computer.

A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and methods have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for identifying and locating objects based on color properties, comprising:
a camera or sensor-enabled device configured to capture images;
a processor coupled to said camera or sensor-enabled device;
a memory in communication with said processor; wherein said memory stores an image processing algorithm configured to analyze the color properties of objects within the captured images; and
a user interface configured to allow a user to select target colors or a range of colors from a live camera feed or image.

2. The system of claim 1, wherein the image processing algorithm further includes normalization features to account for variations in lighting conditions when analyzing the color properties of objects.

3. The system of claim 1, wherein the user interface provides tools for selecting a color range or tolerance in addition to an exact color shade.

4. The system of claim 1, further comprising a histogram analysis module configured to create a graphical representation of the distribution of colors within the captured image, allowing for identification of subtle color variations within a defined tolerance range.

5. The system of claim 1, wherein the processor continuously processes a live feed from the camera, dynamically adjusting target color ranges based on real-time visual feedback.

6. The system of claim 1, further comprising feedback mechanisms including but not limited to visual highlights, auditory alerts, or vibratory cues to indicate to the user the location of an object matching the specified color or color range.

7. The system of claim 1, wherein the user interface is equipped with manual tools allowing users to specify target colors or color ranges, and automated tools for selecting target colors or color ranges based on previously saved images.

8. A method for identifying and locating objects based on their color properties using the system of claim 1, comprising the steps of: capturing an image or a series of images using the camera or sensor-enabled device; processing said image or series of images through the image processing algorithm stored in the memory; and presenting to the user via the user interface objects within the image or series of images that match the selected target color or color range.

9. The method of claim 8, further comprising the step of normalizing the captured image or series of images to account for variations in lighting conditions before processing the image or series of images through the image processing algorithm.

10. The method of claim 8, wherein the step of processing includes analyzing a histogram of the captured image or series of images to identify multiple shades of the target color or color range.

11. The method of claim 8, further comprising the step of providing feedback to the user through one or more feedback mechanisms when an object matching the specified color or color range is identified.

12. The method of claim 8, wherein the step of presenting includes actively highlighting the matching objects on the user interface to differentiate them from non-matching objects.

13. The system of claim 4, wherein the histogram analysis module further allows users to save specific color distributions associated with known objects for future searches.
